(19) United States
(12) Patent Application Publication
(10) Pub. No.: US 2006/0125337 A1
(43) Pub. Date: Jun. 15, 2006

(54) Stainless steel unsealed motor

(76) Inventor: Moshe Levnat, Durham, NC (US)

Correspondence Address: WALL MARJAMA & BILINSKI, 101 SOUTH SALINA STREET, SUITE 400, SYRACUSE, NY, 13202, US

(21) Appl. No.: 10/719,622

(22) Filed: Nov. 21, 2003

(51) Int. Cl. H02K 5/12; H02K 15/14

(52) U.S. Cl. 310/87; 29/596

(57) ABSTRACT

The invention relates to motors and motor assemblies that can be washed without causing corrosion of components, and without causing premature motor failure as a result of corrosion. The motor and motor assembly comprise components constructed from non-corroding stainless steel. The motor and motor assembly are constructed according to an unsealed design, in which washing fluid can enter the motor and the motor housing during washing. The washing fluid can drain away after washing is completed. The unsealed design permits heat generated during operation of the motor to drive off residual washing fluid. The motor and motor assembly can be readily cleaned, easily can be maintained in an corrosion-free state, and are not subject to premature failure from corrosion induced by trapped washing fluid.

### CROSS-REFERENCE TO RELATED APPLICATION

This application is related to an application entitled, “UNSEALED NON-CORRODING WET WASHDOWN MOTOR,” identified further by Attorney Docket No. 847-073, and subject to assignment to the same assignee, which application is being filed on even date herewith.

### FIELD OF THE INVENTION

The invention relates to electric motors used in food or medicine preparation in general and particularly to an electric motor that employs washable stainless steel exposed surfaces.

### BACKGROUND OF THE INVENTION

Motor assemblies used in the food preparation or medicine preparation fields are required to be compatible with FDA regulations. In particular, the FDA has promulgated regulations regarding the absence of corrosion on surfaces that may come into contact with materials such as food and medicines that are undergoing processing. The absence of corrosion requirement has been met using two approaches. In one approach, a fully sealed motor is protected from corrosion by the use of surface preparations such as FDA approved paints. In another approach, the use of a fully sealed motor involves providing a housing made from a non-corroding material such as stainless steel. The surfaces of the motor assembly must be able to undergo cleansing, for example by being washed with solutions that clean and/or disinfect the surfaces of the motor assembly.

The surface of the motor assembly is required to be free of oxidation. During use, the surface of the motor assembly may be subject to mechanical impacts and chemical stresses, such as are possible when materials are mixed or stirred, during such times when substances are added into volumes being mixed, or when materials are removed from mixing or processing containers. In some cases, impacts with other objects may occur by accident.

A number of problems in the use of such washable motor assemblies have been observed. In use, the paint on the surface of painted motor assembly often suffers chipping. The chips in the paint permit the surface of the motor assembly to corrode. In addition, the seals used to seal the motor assembly often are subject to degradation. When the seals fail, water or other cleaning fluid enters the housing and becomes trapped inside the housing. Thermal cycling can cause condensation to form on various parts of the motor. The trapped moisture causes deterioration of the motor winding, which leads to premature motor failure. Such problems result in shortened operational life, and may cause difficulties with regard to maintaining operations in conformity with FDA regulation or oversight.

There is a need for motors and motor assemblies for use in food or medicine preparation applications that are more resistant to corrosion and that are not subject to premature failure.

### SUMMARY OF THE INVENTION

In one aspect, the invention relates to an unsealed washable electric motor assembly for use in food or medicine preparation applications subject to FDA oversight. The unsealed washable electric motor assembly comprises an electric motor having stainless steel exposed surfaces; and an unsealed stainless steel housing configured to admit washing fluid during a washing operation and to allow the exit of the washing fluid upon completion of the washing operation. The washable electric motor assembly is resistant to the effects of corrosive substances, and the electric motor is protected against failure from corrosion by the exiting of the washing fluid from the unsealed stainless steel housing.

In one embodiment, the unsealed stainless steel housing is further configured to permit the washing fluid to be driven off by thermal energy generated by operation of the electric motor.

In another aspect, the invention relates to a method of washing an unsealed washable electric motor assembly. The motor assembly includes an unsealed stainless steel housing and a motor having stainless steel exposed surfaces. The motor assembly is configured to be used in food or medicine preparation activities subject to FDA oversight. The method comprises the steps of washing the unsealed washable electric motor assembly with a washing fluid, whereby the washing fluid is permitted to enter the interior of the unsealed washable electric motor assembly; removing the washing fluid from the unsealed washable electric motor assembly; and operating the electric motor. The residual washing fluid remaining within the unsealed washable electric motor assembly is driven off as a result of the heating of the motor during said operation. The electric motor and said unsealed washable electric motor assembly are cleaned, and said electric motor is protected against failure from corrosion by the driving off of the residual fluid from the unsealed washable electric motor assembly.

In one embodiment, the step of removing the washing fluid from the unsealed washable electric motor assembly includes permitting the washing fluid to drain from the unsealed washable electric motor assembly. In one embodiment, the method further comprises the step of removing the unsealed washable electric motor assembly from an apparatus to which it is mounted prior to performing the washing step.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a cross sectional engineering drawing of a first embodiment of a motor and a motor assembly including a motor, a motor housing and a resolver, according to principles of the invention;

FIG. 2A is a schematic drawing of windings in a stator of a three-phase, eight-pole motor for use in motors that embody principles of the invention;

FIG. 2B is a schematic drawing showing a connection diagram for the wiring in a resolver for use in motors that embody principles of the invention;

FIG. 2C is a diagram showing the relative angular relations among waveforms observed from pairs of motor windings and across terminals of the resolver in motors that embody principles of the invention;

FIG. 3 is a cross sectional engineering drawing of a second embodiment of a motor and a motor assembly including a motor, a motor housing and an encoder, according to principles of the invention;

FIG. 4 is a diagram showing the relative angular relations among waveforms observed from pairs of motor windings and across terminals of the encoder in motors that embody principles of the invention; and

FIG. 5 is a depiction of an embodiment of a rotor with protected stainless steel sleeve shrunk over two stainless steel plates, according to principles of the invention;

### DETAILED DESCRIPTION OF THE INVENTION

The invention solves the problems of corrosion of the motor housing and premature failure of the motor itself by using stainless steel as the material of construction of the various components, and by allowing the washing fluid to enter and to exit the motor assembly, i.e., an unsealed assembly is provided.

In the electric motor arts, motors having different capacities may be used for various applications. The principles of the invention are applicable to motors without regard to the exact size and capacity of a motor. Table I lists a variety of motor sizes and capacities, as approximate relationships. Those familiar with the electric motor arts will understand that motors of larger or smaller size and capacity can also embody the principles of the invention.

TABLE I

| Diameter (inches) | Length (inches) | Horsepower |
|---|---|---|
| 2.25 | 12 | 1.5 |
| 3.5 | 11.75 | 2.5 |
| 4.25 | 15.25 | 4.5 |

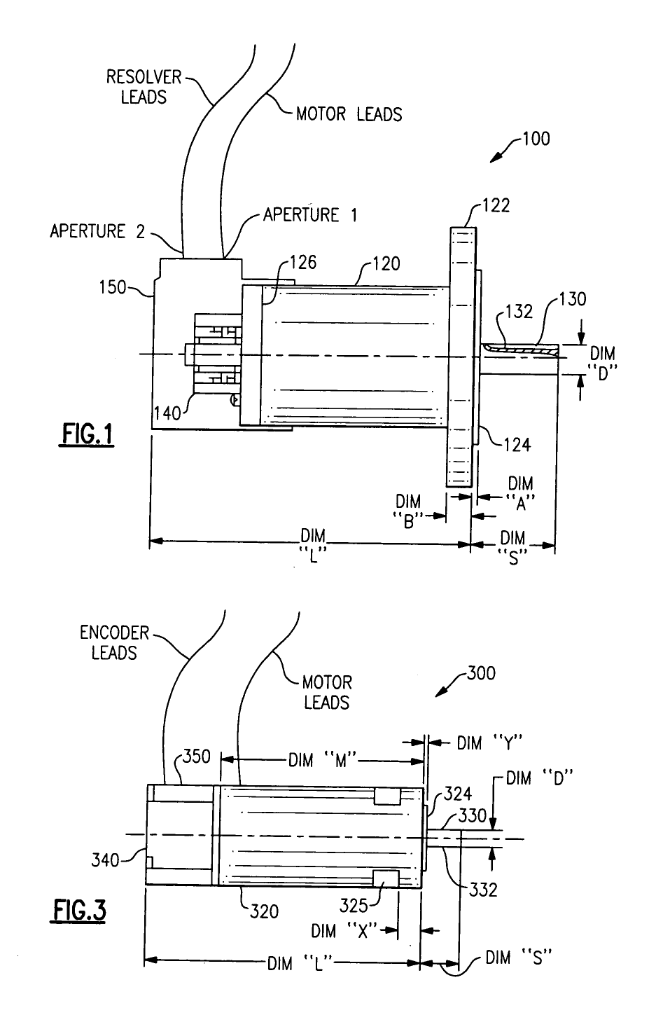

FIG. 1 is a cross sectional engineering drawing of a first embodiment of a motor and motor assembly including a motor, a motor housing, and a resolver. FIG. 1 shows a motor and motor assembly 100, having a motor housing 120, an output shaft 130, and a resolver 140 internal to a resolver housing 150. The motor and motor assembly 100 is unsealed and designed to operate in a wet environment. The motor comprises an unsealed stator designed to operate in a wet environment.

The motor is not shown in FIG. 1. In one embodiment, the motor is based on a conventional three phase eight-pole permanent magnet (PM) motor design. The number of poles is not critical and can be varied while remaining within the scope of the invention. As one example, in a second embodiment a four pole motor can be used in place of an eight pole motor. In one embodiment, the rotor magnet assembly is sealed within a stainless steel sleeve that makes contact with a stainless steel end plate disposed at each end of the rotor magnet assembly, effectively sealing the rotor magnet assembly within a stainless steel “can” or chamber. The motor can comprise a rotor constructed in a single piece design, having a stainless steel sleeve configured to match the outside diameter of a permanent magnet that results in a watertight construction of the rotor. The motor is optionally protected by a thermostatic overheating sensor.

The motor housing 120, and an optional mounting plate 122, if required, is constructed in a single piece design. In other embodiments, the design is a conventional design having a housing and a front end cap. The motor housing is unsealed to allow the entry of washing fluid during a washing operation, and to permit the washing fluid to exit after completion of the washing operation. A preferred material of construction is 300 series stainless steel. A rear end cap 126 is preferably made from 300 series stainless steel. The non-corroding properties of 300 series stainless steel, the thermal transfer characteristics of such steel, and the cost of such steel make it a good choice for use in the environments contemplated.

The motor further comprises bearings. The bearings are sealed type bearings that comprise lubricants compatible with FDA regulation or oversight. One type of FDA-approved lubricant is ThermaPlex FoodLube Bearing Grade Grease provided by LPS Laboratories of 4647 Hugh Howell Road, Tucker, Ga. For example, the bearings are constructed of 316 stainless steel or 440 stainless steel races, shields, and seals. All mounting hardware for the motor and motor housing, such as shims, screws, washers, and the like, are constructed of non-oxidizing materials compatible with FDA regulations.

The motor in the first embodiment includes a resolver 140. The resolver 230 is an unsealed resolver that is enclosed in a stainless steel cover. For example, a suitable resolver is a model 15BRCX available from Danaher Linear Motion Systems of 45 Hazelwood Drive, Amherst, N.Y. 14228. In one embodiment, a resolver that has sufficient resolution and an accuracy of plus or minus 7 arc minutes is used.

The motor is powered and the resolver 140 provides a signal by wiring that is covered with insulation of a type acceptable under applicable FDA regulation or oversight. As shown in FIG. 1, the wires providing power to the motor, identified as “motor leads,” pass through an aperture (aperture 1) in the motor housing and assembly 100. The wires carrying the resolver signals as denoted as “resolver leads” and similarly pass through an aperture (aperture 2) in the motor housing and assembly 100. In one embodiment, Teflon® fluoropolymer material is suitable insulation for wiring for the motor, wiring for resolvers, wiring for encoders, and wiring for Hall sensors. Teflon® is a trademark of E.I. DuPont de Nemours & Co. The features and operation of the first kind of motor described above that provide reduced corrosion and prevent premature motor failure are present in this embodiment as well.

A number of dimensions are indicated in FIG. 1 in schematic format. An overall length of the motor assembly measured from the front mounting surface is denoted as DIM “L.” A shaft diameter is denoted as DIM “D.” The shaft 130 is indicated as having a fiduciary for angular location 132 of an object on the shaft, such as a keyway, a mechanical flat, a spline, an indentation, or the like, so that an object mounted on the shaft can be maintained in a known angular orientation with regard to the shaft. The optional mounting plate 122 has a thickness denoted as DIM “B.” An undercut on the front surface of the optional mounting plate 122 of depth identified as DIM “A” can be provided, thereby creating a raised indexing surface 124 that is useful in locating the motor assembly for installation in and attachment to a piece of machinery.

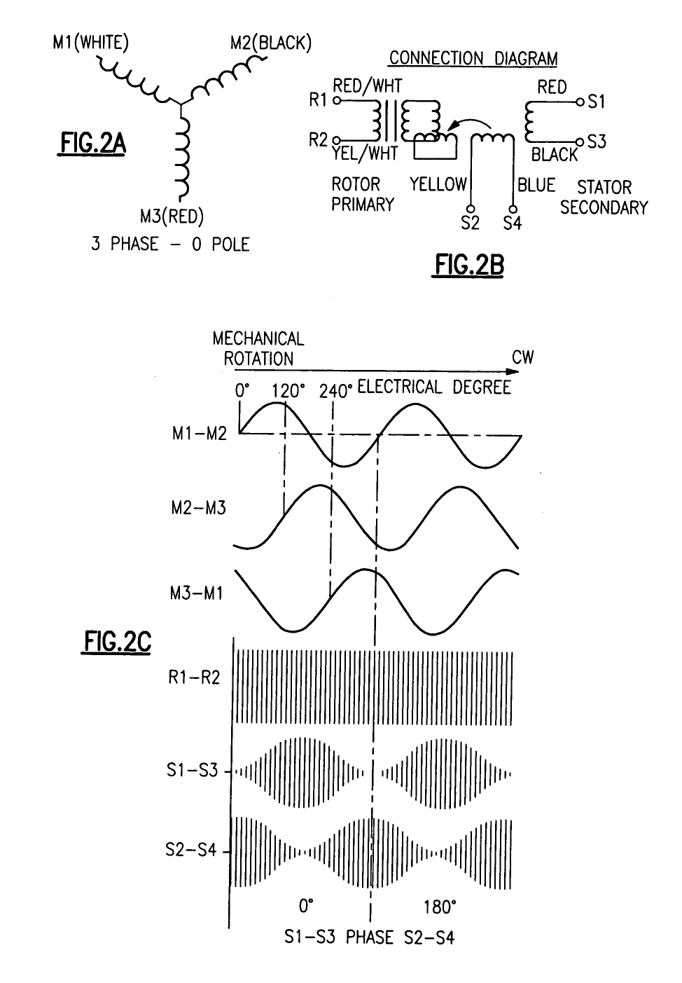

FIG. 2A is a schematic drawing of windings in a stator of a three-phase, eight-pole motor for use in motors that embody principles of the invention. The windings connected in a “star” or “Y” configuration, and are identified by their terminals; terminal M1 (which in one embodiment is identified by a white connection wire), terminal M2 (which in one embodiment is identified by a black connection wire), and terminal M3 (which in one embodiment is identified by a red connection wire). As is well understood in the electrical arts, the center node is maintained at ground potential in a three phase system. As is also well understood by those of skill in the electrical arts, it is possible to connect a three phase system in a “delta” configuration, under proper mathematically specified transformations as compared to a “Y” configuration.

FIG. 2B is a schematic drawing showing a connection diagram for the wiring in a resolver for use in motors that embody principles of the invention. The resolver involves electromagnetic coupling, which is denoted by the symbol for a transformer in FIG. 2B. The rotor spins with the shaft of the motor and produces pulses as shown in FIG. 2C. The secondary windings, being oriented at 90 degrees to each other, produce sinusoidally varying output as a function of the angle of the shaft, with the two output signals being mathematically orthogonal to each other (e.g. in a sine-cosine relationship).

FIG. 2C is a diagram showing the relative angular relations among waveforms observed from pairs of motor windings and across terminals of the resolver in motors that embody principles of the invention, when the motor rotates in a clockwise direction, as viewed from the motor shaft. The curves M1-M2, M2-M3, and M3-M1 are the signals cross pairs of motor winding contacts. The signal R1-R2 is the signal from the rotor of the resolver, and the signals S1-S3 and S2-S4 are the signals from the stator secondary windings of the resolver.

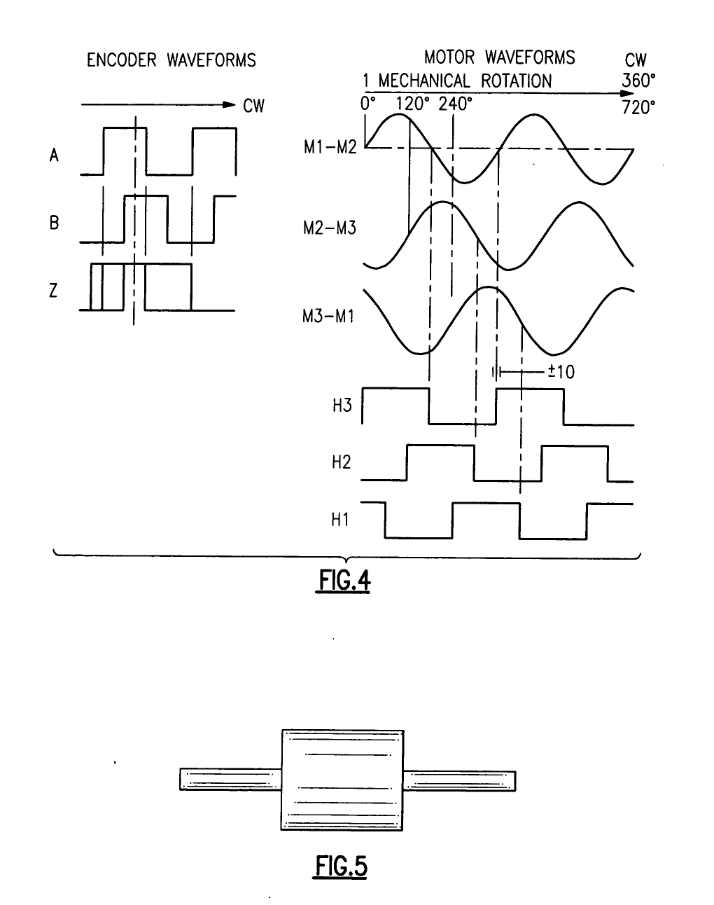

FIG. 3 is a cross sectional engineering drawing of a second embodiment of a motor and a motor assembly 300 including a motor, a motor housing and an encoder. FIG. 3 shows a motor housing 320 and an encoder 340. The motor, which is not shown in the cross sectional diagram, is unsealed and designed to operate in a wet environment. The motor is optionally protected by a thermostatic overheating sensor. The motor comprises an unsealed stator designed to operate in a wet environment. The motor also comprises a rotor constructed in a single piece design, having a stainless steel sleeve configured to match the outside diameter of a permanent magnet (“PM”) assembly and a stainless steel end plate disposed at each end of the PM assembly that results in a watertight construction of the rotor.

In one embodiment, the motor housing 320, and an optional mounting plate, if required, is constructed in a single piece design. Alternatively, a housing, a front end cap and a rear end cap are used, as described above. The motor housing is unsealed to allow the entry of washing fluid during a washing operation, and to permit the washing fluid to exit after completion of the washing operation. A preferred material of construction is 300 series stainless steel. A rear end cap is preferably made from 300 series stainless steel.

The motor further comprises bearings. The bearings are sealed type bearings that comprise lubricants compatible with FDA regulation or oversight. One type of FDA-approved lubricant is ThermaPlex FoodLube Bearing Grade Grease provided by LPS Laboratories of 4647 Hugh Howell Road, Tucker, Ga. For example, the bearings are constructed of 316 stainless steel or 440 stainless steel races, shields, and seals. All mounting hardware for the motor and motor housing 100, such as shims, screws, washers, and the like, are constructed of non-oxidizing materials compatible with FDA regulation or oversight.

The motor and motor housing 300 in the second embodiment includes an encoder 340. The encoder 340 is not operable under wet conditions and therefore is retained in a sealed compartment. The encoder 340 is a commutating encoder that is enclosed in a sealed stainless steel cover. For example, a suitable encoder is a model HS15 encoder available from Cleveland Motion Controls of Billerica, Mass. The HS15 commutating (or non-commutating) encoders are available with up to 5000 points per revolution (PPR). Optionally, an encoder in conjunction with a Hall sensor commutation may be used instead of the commutating encoder. In yet other embodiments, motors can also be built with Hall sensor commutation only.

The motor is powered and the encoder 340 provides a signal by wiring that is covered with insulation of a type acceptable under applicable FDA regulation or oversight. In one embodiment, Teflon® fluoropolymer material is suitable insulation for wiring for the motor, wiring for resolvers, wiring for encoders, and wiring for Hall sensors.

FIG. 3 depicts the wires providing power to the motor, identified as “motor leads.” The motor leads pass through an aperture in the motor housing and assembly 300. The aperture that allows entry of the motor leads need not be sealed against moisture, because the motor housing 320 is not sealed against moisture. The wires carrying the encoder signals as denoted as “encoder leads” and similarly pass through an aperture in the encoder housing 350. Since the encoder cannot tolerate moisture, the aperture in the encoder housing 350 through which the encoder leads pass is sealed with a suitable FDA approved sealant, for example as a pressure seal. Teflon® is a suitable insulating material for encoder lead wiring. The features and operation of the first kind of motor described above that provide reduced corrosion and prevent premature motor failure are present in this embodiment as well.

A number of dimensions are indicated in FIG. 3 in schematic format. An overall length of the motor assembly measured from the front mounting surface is denoted as DIM “L.” A length of the motor housing 320 is denoted as DIM “M.” A shaft diameter is denoted as DIM “D.” The shaft 330 is indicated as having a fiduciary for angular location 332 of an object on the shaft, such as a keyway, a mechanical flat, a spline, an indentation, or the like, so that an object mounted on the shaft can be maintained in a known angular orientation with regard to the shaft. An undercut on the front surface of the motor housing 320 of depth identified as DIM “Y” can be provided. A motor nameplate 325, that provides information about the motor, is situated a distance denoted as DIM “X” from the mounting surface of the motor housing 320.

FIG. 4 is a diagram showing the relative angular relations among waveforms observed from pairs of motor windings and across terminals of the encoder in motors that embody principles of the invention. The waveforms shown are observed when a motor rotates in a clockwise direction as viewed from the motor shaft. The sinusoidal signals represent the waveforms of voltage appearing across pairs of motor winding terminals. The square wave signals denoted H1, H2 and H3 are Hall sensor signals. The Hall sensor signals are used to commutate the motor windings. The encoder waveforms denoted by A, B, and Z, provide signals to control equipment that senses the direction in which the motor system is turning. The motor control equipment also uses the signals to determine a line count, which is equated to a position or velocity of the system.

FIG. 5 is a depiction of an embodiment of a rotor protected with a stainless steel sleeve shrunk over two stainless steel plates, according to principles of the invention. This is an example of the stainless steel “can” construction described hereinabove.

While the present invention has been explained with reference to the structure disclosed herein, it is not confined to the details set forth and this invention is intended to cover any modifications and changes as may come within the scope of the following claims.

What is claimed is:

1. An unsealed washable electric motor assembly for use in food or medicine preparation applications subject to FDA oversight, comprising:
an electric motor having stainless steel exposed surfaces; and
an unsealed stainless steel housing configured to admit washing fluid during a washing operation and to allow the exit of the washing fluid upon completion of the washing operation;
whereby said washable electric motor assembly is resistant to the effects of corrosive substances, and said electric motor is protected against failure from corrosion by the exiting of the washing fluid from the unsealed stainless steel housing.

2. The washable electric motor assembly according to claim 1, wherein the unsealed stainless steel housing is further configured to permit the washing fluid to be driven off by thermal energy generated by operation of the electric motor.

3. A method of washing an unsealed washable electric motor assembly, wherein the motor assembly includes an unsealed stainless steel housing and a motor having stainless steel exposed surfaces, the motor assembly configured to be used in food or medicine preparation activities subject to FDA oversight, comprising the steps of:
washing the unsealed washable electric motor assembly with a washing fluid, whereby the washing fluid is permitted to enter the interior of the unsealed washable electric motor assembly;
removing the washing fluid from the unsealed washable electric motor assembly; and
operating the electric motor, whereby residual washing fluid remaining within the unsealed washable electric motor assembly is driven off as a result of the heating of the motor during said operation;
whereby said electric motor and said unsealed washable electric motor assembly are cleaned, and said electric motor is protected against failure from corrosion by the driving off of the residual fluid from the unsealed washable electric motor assembly.

4. The method of washing an unsealed washable electric motor assembly according to claim 3, wherein the step of removing the washing fluid from the unsealed washable electric motor assembly includes permitting the washing fluid to drain from the unsealed washable electric motor assembly.

5. The method of washing an unsealed washable electric motor assembly according to claim 3, further comprising the step of:
removing the unsealed washable electric motor assembly from an apparatus to which it is mounted prior to performing the washing step.
